(19) United States
(12) Patent Application Publication
(10) Pub. No.: US 2001/0025277 A1
(43) Pub. Date: Sep. 27, 2001

(54) Categorisation of data entities

(76) Inventor: Anders Hyldahl, Copenhagen (DK)

Correspondence Address: BIRCH STEWART KOLASCH & BIRCH, PO BOX 747, FALLS CHURCH, VA, 22040-0747, US

(21) Appl. No.: 09/750,019

(22) Filed: Dec. 29, 2000

Related U.S. Application Data
(60) Provisional application No. 60/176,906, filed on Jan. 20, 2000.

(30) Foreign Application Priority Data
Dec. 30, 1999 (DK) PA1999 01890

(51) Int. Cl. G06F 17/30

(52) U.S. Cl. 707/1; 707/10; 707/513

(57) ABSTRACT

A method for categorising items being data entities stored in a computer system, the method comprising performing categorisation in such a manner that an item and a category are linked if a determined quantification of a relation between said item and said category fulfils a predefined criterion, the said method utilising a list of categories on which the categorisation is to be based, for each category comprised in the list of categorises at least one categorisation function for determining quantification for at least one relation between the category and an item, such as a number, a colour, and/or a text; the quantification of the relation(s) being determined by executing the categorisation function(s), for each item to be categorised, item data to be used for executing the categorisation function(s), the said method comprising, selecting a first set of categorisation functions and a first set of item data, (A) executing the categorisation function(s) comprised in the first set of categorisation functions on item data comprised in the first set of item data thereby determining a first set of quantification of relation(s), and (B) determining whether one or more of the quantification of relations determined fulfil(s) a predefined linking criterion and in case the linking criterion is observed then linking the item and category in question, and optionally selecting a new first set of categorisation functions and a new first set of item data and repeating step (A) and (B) for these new sets.

### CATEGORISATION OF DATA ENTITIES

The present invention relates to a method for categorisation of items being data entities and in particular relates to categorisation of data entities being web pages of a web site.

### BACKGROUND OF THE INVENTION AND INTRODUCTION TO THE INVENTION

Today web sites are indexed by gathering, for instance by crawling, information related to each web page to be indexed. The information relating to each web page typically comprises a path to the page.

A technical problem in connection with such prior art indexing systems is that no information has been made available concerning web pages belonging to same subject matter in the sense that the web pages have been categorised.

Prior art methods have attempted to do a post-categorisation of the indexed web site based on a search string provided by a searcher searching the web site. Based on the search string provided, a search engine will go through a database comprising information to the indexed web site and will evaluate, by use of Boolean algebra, whether the search string or fragments of the search is/are represented in the information. If the search string is represented in the information, then a link to the web page will be presented.

Based on the number of repetition of words in the search string or how many of the words comprised in the search string are represented in the information, a score may be assigned to each hit and the displaying of the hits may be sorted in a way where hits having the highest score are displayed first.

### BRIEF DESCRIPTION OF THE INVENTION

The present invention provides, in a broad aspect, a method for categorising items being data entities stored a in computer system, the method comprising performing categorisation in such a manner that an item and a category are linked if a determined quantification of a relation between said item and said category fulfils a predefined criterion,

said method utilising

a list of categories on which the categorisation is to be based,

for each category comprised in the list of categorises at least one categorisation function(s) for determining quantification for at least one relation between the category and an item, such as a number, a colour, and/or a text; the quantification of relation(s) being determined by executing the categorisation function(s)

for each item to be categorised item data to be used for executing the categorisation function(s),

the said method comprising

selecting a first set of categorisation functions and a first set of item data,

(A) executing the categorisation function(s) comprised in the first set of categorisation functions on item data comprised in the first set of item data thereby determining a first set of quantification of relation(s), and

(B) determining whether one or more of the quantification of relations determined fulfil(s) a predefined linking criterion and in case the linking criterion is fulfilled then linking the item and category in question,

and eventually selecting a new first set of categorisation functions and a new first set of item data and repeating step (A) and (B) for these new sets.

As indicated above, the method according to the present invention deals with categorisation of items being entities in a computer system. In the present context, categorisation of items may be construed as linking item and categories, which covers the situations of items being linked to categories, categories being linked to items and/or item and categories being linked.

Data entities may in this context be computer data of the same kind, for instance a text document, a disk file or a web page. When a data entity is represented in a computer some information from or about the single data entity are typically stored—that may be title of the data entity, date&time of the data entity, size, text-content of the data entity, locator or path to the data entity etc.

According to the present invention, linking is based on a quantification of relation this being a measure of the relation between an item and a category. The quantification of relation may preferably be a number and/or a statement such as false/true.

Applying/providing a quantification of relation in connection with categorisation of items provides a very important and advantageous technical effect. This technical effect is that a measure of the mutual relation ship between an item and a category is provided, on which a decision regarding whether an item and a category are to be linked can be based and on which a decision regarding the relevance of an item within a category can be based.

This technical feature provides a solution to problems encountered in prior art categorisation methods. In these methods items are first linked to a category where upon theirs relevance within a category is determined. As categorisation and relevance of an item are determined as a separate steps, using categorisation rules and relevance rules which are different, the determination of relevance is detached from the categorisation method which very often results in a very less expressive result.

As stated above, the method is categorising items being data entities stored in a computer system. These items are in the broadest aspect of the present invention preferably considered to be any kind of data, such as entities being grouped, data entities stored in a computer, such as in a memory, on a hard disk or the like. Typically items considered are files comprising text, pictures and the like. In a preferred embodiment of the present invention, the items considered are web pages stored on one or several web site(s).

In order to perform the categorisation a list of categories is being supplied, which list may comprise one or more categories. The manner in which the list of categories is provided may depend on the actual application/utilisation of the method according to the present invention. Different ways of providing that list will be described in connection with the description of preferred embodiments of the invention.

In a typical application/utilisation situation of the method, the user of the method may advantageously provide the list of categories and therefore providing of that list may be viewed upon as being supplied by a step being external with respect to the method of invention. But the contents of the list are—of course—utilised by the method according to the present invention and therefore providing that list may be viewed upon as being an integral step of the present invention. The integral/external principle outlined above applies also to providing of categorisation function(s) and item data.

In such and other preferred embodiments of the present invention the categorising method is applied successively in the sense that a first categorisation is based on a first list of categories. The result of this first categorisation is then categorised based on a second list of categories, which may be determined/provided on the basis of the first categorisation result. In a preferred embodiment of the present invention, the second list comprises sub-categories to a category.

In yet other preferred embodiments, which may be applied/utilised in combination with the above-mentioned embodiments of providing the list of categories, the list of categories is being built such as constructed, during application of the method.

A quantification(s) of relation is determined by executing a categorisation function. The term categorisation function may be construed in the present context as a function which takes as input information relating to data entities to be categorised and which provides an output quantifying the relation between a category and an item.

As input to—or argument for—the categorisation functions is information relating to or corresponding to the items to be categorised, this information is being provided as item data. Typically, item data are extracted from the items and the content of the item data corresponds to the input to the categorisation function, but the item data may also comprise information to be processed before being used as argument for the categorisation functions. The content of the item data may preferably be static information relating to the items and/or information provided by processing the items.

By using the concept of categorisation functions another very advantageous technical effect is provided. As more than one categorisation function may be provided for one category, items being of different nature, such as a picture or text, may easily be categorised by the method according to the present invention. In prior art categorising methods categorisation of items having different nature normally require a huge number of logical operations.

According to the broad aspect of the present invention determination of the quantification of relations and linking of items and categories are performed in the above mentioned steps (A) and (B). These steps are preferably initiated by selecting a first set of categorisation functions and a first set of item data. Preferably, depending on the actual implementation and/or application of the method according to the invention, the first set of categorisation function may comprise one categorisation function or more than one categorisation function, and also depending on the actual implementation/application of the method the first set of item data may comprise item data corresponding to one or more items.

In step (A) of the broad aspect of the present invention the categorisation function(s) is/are executed on the item data provided. This execution will, as stated, provide a first set of quantification('s) of relation, the number of which corresponds to the number of categorisation functions and item data.

In step (B) of the broad aspect of the present invention the linking is performed for the item(s) and category(ies) considered in step (A). The linking is based on determination of whether a predefined or in general a defined linking criterion is fulfilled.

The criterion is typically predefined by assigning a criterion to each of the categorisation function and/or by prescribing a criterion common for all categorisation functions or for a selection of categorisation function. The criterion may also very advantageously be defined during application of the method. Once such case could be a situation wherein a restriction to the number items within a category has been prescribed which number may be applied to set a lower limit on the quantification of relation to be observed for linking.

The manner of selecting the first sets is as indicated above preferably depending on the actual implementation/application of the method. In case not all of the item data provided and/or not all of the categorisation function(s) provided have been selected, and the categorisation is to be performed on all the items and categories provided then a new first set of categorisation function(s) and/or a new first set of item data is to be selected. In this is the case step (A) and (B) are repeated for the new first sets selected. Furthermore, this procedure may be repeated until no further functions and/or no further item data are to be considered.

Furthermore, as effectuation of linking is based on a linking criterion a categorisation of a number of items may very easily be altered in case recording of the quantification of relations has been performed. In this case defining another linking criterion and then repeating step (B) for this new criterion may accomplish a re-categorisation. This situation is, of course, considered comprised in the method according to the present invention also.

In certain preferred embodiments of the present invention the items to be categorised are grouped and each group is then considered as an item to be categorised. The item data corresponding to such a group may preferably be a head item for the group and once the head item is categorised the remaining items in the group are categorised according to the head item.

The way in which the different steps according the method are ordered should not be regarded as being dominant for the method. For instance the step “selecting a first set of categorisation function and a first set of item data” may be included or be inherent in step (A) as will be described in connection with descriptions of preferred embodiments of the method. Also, the selecting of a first set of item data may be inherent in providing item data, for instance in the case where this selection comprises selection of all the item data provided, in which case the first set of data may comprise all the item data provided.

Furthermore, the division of the operation comprised in step (A) and step (B) should not be construed in the sense that these step have to be executed independently of each other. For instance, step (A) may very advantageously be executed for one categorisation function where after step (B) is executed based on the result of step (A), which sequence may be repeated until all the categorisation function(s) comprised in the first set of categorisation function has been executed.

In a preferred embodiment of the method the grouping of items considered is the partitioning of items into directories in a computer system. The head items are then considered being main directories and once these main directories are categorised the content of these main directories are categorised similar to the main categories. In a particular important embodiment/application of the method the item data is/are path(s) to a main directory(ies) for each group and once these directories have been categorised, the items in the main directories and sub-directories thereto is categorised according to the categorisation of the main directory.

In a preferred embodiment of the method according to the present invention step (A) of the broad aspect comprises the steps of

(a) selecting an item data from the first set of item data,

(b) executing the categorisation functions comprised in the first set of categorisation functions on the selected item data thereby determining quantification of relations, and

(c) if the first set of item data comprises non-selected item data or more item data are to be selected then selecting a new item data and repeating step (b) until no further item data is to be selected.

In this preferred embodiment, categorisation relating to one item at a time is considered and step (B) of the method according to the broad aspect is performed based on the selected item and the quantification('s) of relation corresponding thereto.

Selection of an item date from the first set of data may be considered being performed inherently in the selection of a first set of item data in case the method is applied/implemented in a manner in which the selection of the first set of item data comprises selection of only one item. This is particular useful in embodiments of the method in which categorisation of items is performed on the fly, i.e. in the situation wherein an items is categorised when it's item data is provided.

This preferred embodiment of the present invention might be viewed upon as comprising an outer and an inner loop. The outer loop may be seen as the operation(s) involved in providing item data and the categorisation function(s) to be considered for the item. The inner loop may be seen as a loop running through all the categorisation functions thereby providing the quantification('s) of relations and performing the linking.

This embodiment of the method according to the invention has the advantage of speeding up the categorisation, especially in a situation in which a linking criterion is applied in such a manner that once the criterion has been observed for a quantification of relation no need for looking for another fulfilment observing the criterion is necessary whereby the determination of quantification's may be interrupted and a new item may be selected.

In a second preferred embodiment, linking between one category and more than one item at a time is considered and accordingly step (A) of the method according to the broad aspect of the invention comprises the steps of

(a) selecting a categorisation function from the first set of categorisation functions,

(b) executing said selected categorisation function on the item data comprised in the first set of item data thereby determining quantification of relation(s), and

(c) if the first set of categorisation function comprises a non-selected categorisation function or if more categorisation functions are to be selected then selecting a new categorisation function and repeat step (b) until no further categorisation function is to be selected.

This embodiment of the invention may serve the purpose of finish up linking between one category and more than one item at a time. This may be very advantageously and may be applied when performing a re-categorisation in which one category out of a list of categories has been altered. In this case links between the new category and items may be performed independently of the former categorisation. Also, this embodiment may be applied in case one or more categories are added to a former categorisation. Again, step (B) of the method according to the broad aspect is performed based on the items and the quantification's of relation corresponding thereto.

Also this embodiment of the present invention may be seen as comprising an inner and an outer loop. In such cases the outer loop might be seen as comprising the operations providing item data and selecting item data and the inner loop might been as the determining quantification of relations for all the item data considered.

Selection of a new item data or a new categorisation function may be interrupted when no more item data are to be selected or when no more categorisation functions are to be selected. Thereby these embodiments may be viewed as a hybrid version comprising categorisation of a number of items according to this preferred embodiment and comprising categorisation by using other embodiments of the method for the remaining number of items to be categorised.

According the to first and the second preferred embodiment of the method, step (B) may preferably be performed when either

no further item data is to be selected. or

no further categorisation function is to be selected.

In presently most preferred embodiments of the present invention step (B) according to the broad aspect of the method is performed when a quantification of relation(s) has been determined.

In another aspect of the present invention a method has been provided which method, in case the linking criterion is fulfilled, further comprises the step of determining whether further quantification of relation(s) corresponding to the item for which the linking criterion has been fulfilled has to be determined.

This embodiment is particular useful in situation wherein the categorisation of an item may include linking an item and more than one category. In this situation the determination of whether further quantification of relation(s) has to be determined may be inhabitant in the method/implementation of the method according to the invention. This may for instance be the case if the method is so implemented or applied that all categorisation functions are executed on the item data corresponding to said item or said determination may be based on an evaluation of for instance the quantification of relation. The latter may be applied as a step to provide a measure for the linking of one item and one category relatively to said item and another category.

Preferably, the item data to be used in executing the categorisation function(s) in the method according to the present invention comprises predefined information relating to the categorisation. The information is preferably predefined in such a way that when an item is located the information is extracted from the item.

In preferred embodiments of the method, the predefined information relating to the categorisation is selected from the group consisting of file name, file extension, the content of a meta-tag, language of the data entity (optionally the language of the item data), position in a directory, individual item or item data assignment and URL.

When the categorisation is performed on the basis of item data the categorisation function utilised in the method comprise a function type performing textual processing. The term textual processing covers processing based on or processing of characters. Besides being able to do textual processing the functions may also be adapted to perform processing of graphic information and/or numbers. The result of the processing may preferably be numbers, characters and/or bit-patterns.

In another very important aspect of the present invention step (B) of the method further comprises consulting one or more additional categorisation rules and/or one or more additional functions, the additional categorisation rule(s) and the additional function(s) being adapted to determine whether the quantification of relation(s) for the item is valid, and if the result of the consultation indicates that the quantification of relation(s) is non-valid then

(i) changing the item data corresponding to the item in question in combination with executing the categorisation function(s) on the item data thereby altering the quantification of relation(s) of the item data, or

(ii) altering the quantification of relation(s) based on the additional rule and/or the additional function

or performing a combination of step (i) and (ii).

A quantification of relation may preferably be considered to be valid in case consultation of the additional categorisation rule(s) and/or additional function results in that neither the item data nor the quantification corresponding thereto is subjected to the changed. If the consultation reveals that the quantification of relation(s) for the item in question is not valid then either the item data are changed or the quantification(s) of relation is(are) changed or a combination of those measures.

This aspect of the method is especially applicable for error correction purposes and/or for applying a superior categorisation disabling categorisation for a subset of items, said subset being preferably defined by the additional rules and/or additional functions.

In another preferred embodiment of the method according to the invention the predefined linking criterion may preferably be that linking is provided between an item and a category if the quantification of relation(s) corresponding to said item and said category is the largest compared to quantification of relation(s) corresponding to said item and all other categories.

In yet another preferred embodiment of the method according to present invention the predefined linking criterion may preferably be that linking is provided between an item and a category if the quantification of relation(s) is within a particular interval. The interval may be defined by an upper and/or lower limit, which limits may preferably be expressed by number and/or characters.

In some applications of the method the interval may preferably determined during the categorisation. One preferred way of determining the interval to be observed is based on statistics relating to the determined quantification's of relations. If for instance the quantification's of relations are mostly represented around a specific quantification then the limits may preferably be set so that only the items represented around that specific quantification observe the criterion.

In an important aspect of the present invention the categorisation is applied to a web site. In this specific aspect the items to be categorised are preferably web pages. Categorisation of web pages not being a part of a web site may of course also be categorised by the method according to the present invention.

In a preferred aspect of the present invention the item data on which the categorisation is based are collected by a method comprising, crawling the web site, locating items to be categorised and for each of those located items collecting item data to be used in executing the categorisation function(s). The crawling is typically performed by use of a crawler—also called a robot, a worm, a spider or the like being set-up to locate items to be categorised. The crawler may perform the collecting of item data or the crawler may gather information relating to the items which information may be used by another means adapted to extract item data from the items.

Preferably the collecting of item data comprises interpreting the contents of items so that item data collected corresponding to an item may comprise data related to the content of the item and/or the content such as fragments of the item.

In a preferred embodiment of the method the interpreting is done during the collecting of the item data and in another preferred embodiment the interpreting is done after the collecting of the item data.

Preferably the crawling of the web site comprises crawling by descriptors, such as paths to web pages and/or paths to web pages in combination with content of specific read data from the web pages.

In yet another preferred embodiment of the method according to the present invention a new category or new categories to be added to the list of categories are provided by executing the categorisation function(s) and/or consulting the additional rule(s) and/or the additional function(s).

### DETAILED DESCRIPTION OF PREFERRED EMBODIMENTS OF THE INVENTION

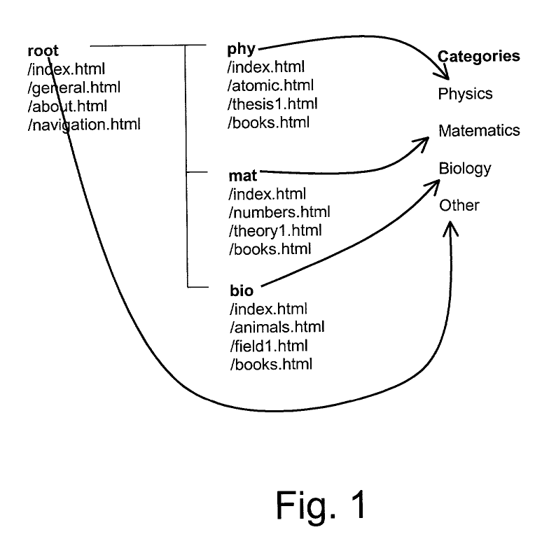

In the following preferred embodiments of the method according to the present invention will be described by way of examples and with reference to FIG. 1 accompanying the examples, which figure shows:

linking of items located at a web site during a crawling process and categories.

The method will be described in at least two sections, one describing the actual categorisation and one describing the use of the categorisation result.

### Categorisation

In order for the categorisation to be carried out data-items, or information relating thereto, to be categorised must somehow be provided. In the preferred embodiments described herein the categorisation is applied to data-items being documents such as web pages located on a web site, but the method according to the invention is, of course, not limited to categorisation of such documents.

Such web pages are uniquely defined by a URL, a uniform resource locator, being such as file name and path, and documents are “collected” by a well known crawling process utilising a worm which crawls the web site and locates web pages corresponding to a set-up of the worm or the crawling process in general.

It should be noted that the documents are not collected in the sense that documents are actually copied to another location but the term collected is used to denote the process of identifying documents corresponding to the set-up of the crawling process and extracting information to be used during categorisation such as data from the so called META-tag and URL's corresponding to such documents.

Once the web site has been crawled a list of data entities has been provided and the categorisation is ready to be launched. This list will according to the above discussion comprise a list of URL's and/or other information characterising the documents and being useful for the process of categorisation.

The categorisation method is based on a categorisation list. Each item in the categorisation list comprises a categorisation function that provides by execution a value being termed quantification of relation. The quantification of relation may be viewed upon as a measure for how close a fit there is between a category and a document. Furthermore, each category is typically assigned a name and the result obtained by executing the categorisation function is assigned a categorisation identity number, a cat_id, corresponding to that category the function relates to. This may be exemplified by the following.

A list of categorisation functions may have the following general appearance:

func_{—}1(url_i)→Value_{—}1;Cat_id_{—}1

func_{—}2(url_i)→Value_{—}2;Cat_id_{—}2

func_n(url_i)→Value_n;Cat_id_n

Here it is assumed that n categorisation functions are present corresponding to n categories into which documents may be categorised. Furthermore, it is by the writing url_i indicated that it is the url corresponding to the i'th document that is used as an argument to the categorisation function.

The writing “→Value_x;Cat_id_x” indicates that the result of executing the categorisation function is at least a value quantifying the relation between the document in question and the category in question. Cat_id is preferably inherent in the process as the functions are related to categories, but executing the functions may in some situations derive the Cat_id.

The above example is an example often referred to as categorisation by directory structure. As will become clear from the following the method is not limited to such cases as the method may apply any kind of categorisation functions as long as execution of those provides a value so as a quantification of relation is provided by execution.

More specifically, a categorisation function corresponding to category represented by cat_id=3 may have the following appearance: 3,/dir1/dr*/test.*. In this function the wild card “*” has been used to indicate that any character and number thereof may take the place of the “*”, but other wild-cards system's such as [#@ a/b] may be applied. The document considered categorised may have url=/dir1/drp5/test.html. Formally the execution of the function may be written as

(/dir1/dr*/test.*) ˆ (/dir1/drp5/test.html)

in which the operator ˆ is defined as the number of letters in the intersection, i.e.

| | | | | | | | | | | | | | | | | |
|---|---|---|---|---|---|---|---|---|---|---|---|---|---|---|---|---|
| / | d | i | r | 1 | / | d | r | * | / | t | e | s | t | . | * | |
| / | d | i | r | 1 | / | d | r | p5 | / | t | e | s | t | . | html | |
| 1 | 1 | 1 | 1 | 1 | 1 | 1 | 1 | 0 | 1 | 1 | 1 | 1 | 1 | 1 | 0 | =14 |

The operator is also defined in such a manner that if there is one or more character inconsistently between the two arguments then the number of letters in the intersection is per definition zero. For instance, evaluation of (/dir14/test.*) ˆ (/dir1/drp5/test.html) results in 0 as will shown below.

As stated above, the linking of a document and a category is based on the quantification of relation and in the preferred embodiment of the present invention a document in question is only to be linked to one category. The criterion to be fulfilled for linking a document and a category is in this preferred embodiment the following: the document is linked to the category for which evaluation of the corresponding function provides the highest quantification of relation.

This may be exemplified by the following example. If the functions a), b) and c) to be considered are

a) 1,/dir1/dr*/egon.*

b) 2,/dir1/dr*/test.*

c) 3,/dir14/test.*

and the document to be categorised is /dir1/drp5/test.html then the evaluation of the functions will provide quantification's of relation:

a) (/dir1/dr*/egon.*)ˆ (/dir1/drp5/test.html)=8

b) (/dir1/dr*/test.*)ˆ (/dir1/drp5/test.html)=14

c) (/dir14/test.*)ˆ (/dir1/drp5/test.html)=0

As the evaluation of the functions results in b) having the highest value then the document represented by /dir1/drp5/test.html and the category represented by cat_id=2 are linked.

In another example a category may have more than one function assigned which may be exemplified by the functions:

a) 1,/dir1/dr*/egon.*

b) 2,/dir1/dr*/test.*

c) 2,/dir14/test.*

indicating that the function a) is assigned to category 1 and b), c) are assigned to category 2. Evaluation of the function will in this example result in the same quantification's of relations as above and the document represented by /dir1/drp5/test.html and the category represented by cat_id_{—}2 are linked.

The actual implementation of the linking process may be done in many different ways, but in the preferred embodiment the executing process has been implementing in the following way. Each time the crawling process has located a document to be categorised, all the functions are executed. The linking process is initiated by executing the first function in the list and the value resulting from this execution is recorded. For the reason of clarifying the discussion only this value is denoted the old value. Then the next function is executed and the value resulting thereby (denoted the new value for clarity only) is compared to the recorded value. If the old value is smaller than the new value then the new value is recorded and old value is deleted. This procedure is repeated for the remaining functions which results in that when all the functions has been executed then only the largest quantification of evaluation is recorded which then provides the information relating to category and document to be linked.

Alternatively to the linking procedure described above the linking may be performed after the crawling process has located all the documents to be located, and the execution of the functions may be done in such a manner that one function is executed on all documents.

A specific important feature of the categorisation method according to the present invention is the methods ability to provide a complete categorisation. This has been provided be including a completion function which when executed will provided a quantification of relation being different from zero independent of the document.

An example of a document which according to the example function stated above would provide a quantification of relation being equal to zero is a document having an url equal /dir14/test.html. The evaluation of the function is

| | | | | | | | | | | | | | | | | | |
|---|---|---|---|---|---|---|---|---|---|---|---|---|---|---|---|---|---|
| / | d | i | r | 1 | | / | d | r | * | / | t | e | s | t | . | * | |
| / | d | i | r | 1 | 4 | / | t | e | s | t | .h | t | m | l | | | |
| 1 | 1 | 1 | 1 | 1 | break | | | | | | | | | | | | =0 |

“break” indicates that an discrepancy is found an no more comparison is to be done. When a discrepancy is found the ˆ -operator provides a zero as result.

The completion function could in the present example be expressed as cat_id,/* and the category identity, cat_id, could most suitable refer to a category termed “Other”. Execution of this function will always result in a number being different from zero as all URL always starts with “/” and the wildcard “*” will accept all characters. By applying such a function pages or in general documents which does fit in some of the other categorises goes into the category Other. Furthermore, as this function is similar to the other functions applied the completion function is simply included into the list of functions.

During the categorisation, a situation in which evaluation of two functions gives the same value may occur. Recalling the discussion of the implementation of the sequentially execution of the function will shown that the linking is performed between the category corresponding to the first function providing the largest value and the document in question. This is due to the fact that if a new value is equal to the old value then the new value is not larger than the old value (of course) and the new value will therefore be dropped.

In this case the list of functions is hierarchically arranged having the highest prioritised category arranged as the first, i.e. the first function in the list of functions is the one corresponding to the category having the highest rank.

A system in which the data-item is assigned to both categorises is possible and in this situation more than one old value is recorded.

The method according to the present invention may very advantageously be used in a kind of recursive manner. In this case, documents are first categorised according to a master list thereby arranging the documents in master categories. Documents arranged in such a master category are then categorised according to a sub-list used for categorising documents in sub-categories.

Until now the list of categories and thereby the list of functions have just been stipulated as being provided. In the following, the way of constructing/providing the categories/functions is described.

First time a web site is categorised the worm crawls through the site and extracts documents to be categorised. These documents will typically be directories and a limited number of files, as an extraction of all the real documents typically would result in a very large number of documents.

By this first crawling a site-map is generated which comprises information regarding all found directories and theirs content. In a preferred embodiment of the present invention this site-map is visualised on a computer screen.

The user provides a number of categories, which also may be visualised. Once the site-map and the categories are provided, generation of the categorisation function can be performed by linking data entities present in the site-map and categories.

For instance, the crawling process may have located the following items on the web site www. science.tst, which documents are linked with the categories following below and depicted in FIG. 1:

The arrows in FIG. 1 are used for indicating links between the items and categories. In this situation the categorisation functions could be

a) ‘Other’,/*

b) ‘Physics’,/phy/*

c) ‘Matematics’,/mat/*

d) ‘Biology’,/bio/*

In this example each line between a document and a category represents a categorisation function to be constructed. After this first assignment, which typically is provided by a user of the method the documents, which in this case are directories, are examined and this examination provides the functions.

Selecting for each directory a category from a list of pre-defined categories performs generation of the categorisation functions. This is done on a computer screen and the appearance thereof might be like the Windows Explorer™, i.e. directories shown to the left and file content shown to the right, but added the possibility of choosing categories in a so called drop down list-box. By “clicking” on a directory, sub-directories thereto are shown. The generated categorisation function is then the name of the chosen category added the wild card “*”. This simple way of generating categorisation functions might be made more sophisticated by adding the possibility of choosing separate web pages and/or adding rules assigned to a selected directory.

The categorisation method may also be used such as to provide a possibility of arranging data according to more than one categorisation. For instance a web site or in general the content of a storage medium may be categorised based on internal organisation of the company owning the web site or it may be categorised based content analysis.

In this case the method according to the present invention is applied to two sets of categories each having a list of categorisation functions.

Until now the method according to the present invention has been described in a way where execution of the categorisation functions is performed when the data entities are present. In a presently most preferred embodiment, the execution of the categorisation function is performed when ever possible, which typically is when a document has been located. By this manner of executing the categorisation functions each time a document has been located no memory is used for storing the data-items until processing. It should be noted, that architecture of the computer used for categorisation may be so that it is advantageously to locate a number of data-item before execution of functions is performed, which number of data-items may be adapted to cache size or the like.

Furthermore, the method according to the present invention does not require a full categorisation of all the data entities when the number and/or types of data entities are changed.

As described above, the documents or theirs representation comprises a cat_id being the result of the categorisation method, and as this cat_id is determinable, in general, independently of determination of cat_id's for other data-items a new data-item may be categorised when appearing.

### Use of the Categorisation

The result of applying the method according to present invention is that the data-items are categorised. This result may be used in many different ways for instance to organise data in general or as it is the case in the presently most preferred embodiment of the present invention used in connection with displaying hits found by a search on for instance a web site.

Such a search will in general provide a number of documents being selected by a search criterion/criteria from the categorised web site. The documents selected are typically arranged in list being subjected to presentation. The documents within these list are represented by a locator such as an url pointing/locating the document and cat_id corresponding to the document, which cat_id also represents the category to which the documents are linked and vice versa.

Displaying of the search result comprises the step finding data-items having the same cat_id and arranging these data-items in a list of items to be displayed together with displaying the name of the category.

1. A method for categorising items being data entities stored in a computer system, the method comprising performing categorisation in such a manner that an item and a category are linked if a determined quantification of a relation between said item and said category fulfils a predefined criterion,
the said method utilising
a list of categories on which the categorisation is to be based,
for each category comprised in the list of categorises at least one categorisation function for determining quantification for at least one relation between the category and an item, such as a number, a colour, and/or a text; the quantification of the relation(s) being determined by executing the categorisation function(s)
for each item to be categorised, item data to be used for executing the categorisation function(s),
the said method comprising
selecting a first set of categorisation functions and a first set of item data,
(A) executing the categorisation function(s) comprised in the first set of categorisation functions on item data comprised in the first set of item data thereby determining a first set of quantification of relation(s), and
(B) determining whether one or more of the quantification of relations determined fulfil(s) a predefined linking criterion and in case the linking criterion is observed then linking the item and category in question,
and optionally selecting a new first set of categorisation functions and a new first set of item data and repeating step (A) and (B) for these new sets.

2. A method according to claim 1, wherein step (A) of claim 1 comprises the steps of
(a) selecting an item data from the first set of item data,
(b) executing the categorisation functions comprised in the first set of categorisation functions on the selected item data thereby determining quantification of relations, and
(c) if the first set of item data comprises non-selected item data or more item data are to be selected then selecting, a new item data and repeating step (b) until no further item data is to be selected.

3. A method according to claim 1, wherein step (A) of claim 1 comprises the steps of
(a) selecting a categorisation function from the first set of categorisation functions,
(b) executing said selected categorisation function on the item data comprised in the first set of item data thereby determining quantification of relation(s), and
(c) if the first set of categorisation function(s) comprises a non-selected categorisation function or more categorisation functions are to be selected then selecting a new categorisation function and repeat step (b) until no further categorisation function is to be selected.

4. A method according to claim 2, wherein the step (B) of claim 1 is performed when either
no further item data is to be selected. or
no further categorisation function is to be selected.

5. A method according to claim 3, wherein the step (B) of claim 1 is performed when either
no further item data is to be selected. or
no further categorisation function is to be selected.

6. A method according to claim 1, wherein step (B) of claim 1 is performed when a quantification of relation(s) has been determined.

7. A method according to claim 1, which method, in case the linking criterion is fulfilled further comprises the step of determining whether further quantification of relation(s) corresponding to the item for which the linking criterion has been fulfilled has to be determined.

8. A method according to claim 1, wherein the item data to be used in executing the categorisation function(s) comprises predefined information relating to the categorisation.

9. A method according to claim 8, wherein the predefined information relating to the categorisation is selected from the group consisting of file name, file extension, the content of a meta-tag, language of the data entity and/or of the item data, position in a directory, individual item and item data assignment and URL.

10. A method according to claim 1, wherein the categorisation function comprises a function type performing textual processing.

11. A method according to claim 1, wherein step (B) of claim 1 further comprises consulting one or more additional categorisation rules and/or one or more additional functions, the additional categorisation rule(s) and the additional function(s) being adapted to determine whether the quantification of relation(s) for the item is valid, and if the result of the consultation indicates that the quantification of relation(s) is non-valid then
(i) changing the item data corresponding to the item in question in combination with executing the categorisation function(s) on the item data thereby altering the quantification of relation(s) of the item data, or
(ii) altering the quantification of relation(s) based on the additional rule and/or the additional function
or performing a combination of step (i) and (ii).

12. A method according to claim 1, wherein the predefined linking criterion is that linking is provided between an item and a category if the quantification of relation(s) corresponding to said item and said category is the largest compared to quantification of relation(s) corresponding to said item and all other categories.

13. A method according to claim 1, wherein the predefined linking criterion is that linking is provided between an item and a category if the quantification of relation is within a particular interval.

14. A method according to claim 13, wherein the interval is determined during the categorisation.

15. A method for according to claim 1, wherein the items to be categorised are data entities on a web site.

16. A method for according to claim 1, wherein the items to be categorised are web pages.

17. A method according to claim 15, wherein the item data on which the categorisation is based are collected by a method comprising, crawling the web site, locating items to be categorised and for each of those located items collecting item data to be used in executing the categorisation function(s).

18. A method according to claim 16, wherein the item data on which the categorisation is based are collected by a method comprising, crawling the web site, locating items to be categorised and for each of those located items collecting item data to be used in executing the categorisation function(s).

19. A method according to claim 17, wherein the collecting of item data comprises interpreting the contents of items so that item data collected corresponding to an item may comprise data related to the contents of the item and/or the contents such as fragments of the item.

20. A method according to claim 18, wherein the collecting of item data comprises interpreting the contents of items so that item data collected corresponding to an item may comprise data related to the contents of the item and/or the contents such as fragments of the item.

21. A method according to claim 19, wherein the interpreting is done during and/or after the collecting of the item data.

22. A method according to claim 20, wherein the interpreting is done during and/or after the collecting of the item data.

23. A method according to claim 17, wherein the crawling of the web site comprises crawling by descriptors, such as paths to items and/or paths to items in combination with names of items.

24. A method according to claim 18, wherein the crawling of the web site comprises crawling by descriptors, such as paths to items and/or paths to items in combination with names of items.

25. A method according to claim 1, wherein a new category or new categories to be added to the list of categories are provided by executing the categorisation function(s) and/or consulting the additional rule(s) and/or the additional function(s).

26. A method according to claim 1, further comprising the step of
providing a list of categories on which the categorisation is to be based,
providing for each category comprised in the list of categorises at least one categorisation function for determining quantification for at least one relation between the category and an item, such as a number, a colour, and/or a text; the quantification of the relation(s) being determined by executing the categorisation function(s)
providing for each item to be categorised, item data to be used for executing the categorisation function(s).

27. A computer product directly loadable into the internal memory of a digital computer, comprising software code portions for performing the steps according to claim 1 when said product is run on a computer.
